(19) United States
(12) Patent Application Publication
(10) Pub. No.: US 2026/0039589 A1
(43) Pub. Date: Feb. 5, 2026

(54) METHOD FOR DYNAMIC DATA DISTRIBUTION IN LOAD BALANCING

(71) Applicant: Cisco Technology, Inc., San Jose, CA (US)

(72) Inventors: Sathish Revuri, Dublin, CA (US); Srinivas Pitta, Cupertino, CA (US)

(21) Appl. No.: 18/792,366

(22) Filed: Aug. 1, 2024

(51) Int. Cl. H04L 45/00; H04L 43/0882; H04L 47/125

(52) U.S. Cl. CPC H04L 45/38; H04L 43/0882; H04L 47/125

(57) ABSTRACT

Techniques are provided herein for implementing hybrid path selection for use in load balancing operations. The techniques may comprise initially implementing a first data distribution technique to distribute data packets across a set of paths. The techniques may then comprise upon determining an amount of network traffic handled by the edge device is above a threshold amount of network traffic, identifying, based on one or more values associated with the set of paths, that a first path of the set of paths is underutilized, receiving a first data packet directed to a destination, assigning the first data packet to the first path in a flow table associated with a second data distribution technique, and routing the first data packet across the first path in accordance with the second data distribution technique.

### TECHNICAL FIELD

The present disclosure relates generally to computer networks, and more particularly, to dynamically transitioning between data distribution techniques during load-balancing operations.

### BACKGROUND

With the emergence of technologies such as Infrastructure as a Service (IaaS) and Software as a Service (SaaS), the resulting virtualization of services has led to a dramatic shift in the traffic loads of many large enterprises. Indeed, many SaaS services can now be reached in a typical deployment via a number of different network paths. However, path selection can also greatly impact the quality of experience (QoE) associated with a given SaaS application. For instance, delays, losses, or jitter along the routing path can lower the QoE of the SaaS application.

In modern networks, especially those handling large volumes of data and artificial intelligence (AI) workloads, efficient traffic distribution is crucial. Traffic may be balanced across the physical links using different algorithms. For example, a hashing algorithm may rely on characteristics of a traffic flow, such as source IP address, destination IP address, source MAC address, destination MAC address, etc., to assign a given flow to an interface of a port-channel. Typically, a forwarding engine on a network device running the port-channel supports a single hashing algorithm. The algorithm evaluates a hash function, and the forwarding engine routes the channel traffic to the corresponding physical links based on the result.

However, hashing algorithms typically do not consider available bandwidth as a factor in load balancing traffic. Hence, the use of a hashing algorithm may lead to uneven load sharing, underutilized bandwidth in other links, and dropped packets in the links where percentage utilization has reached 100%. More generally, the performance of an algorithm for assigning flows to interfaces in a port-channel can vary depending on the flows that actually occur.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a block diagram illustrating an example network deployment environment that may be implemented in accordance with at least some embodiments.

FIG. 2A depicts a first block diagram illustrating a process for distributing data packets dynamically using multiple data distribution techniques in accordance with some embodiments.

FIG. 2B depicts a second block diagram illustrating a process for distributing data packets dynamically using multiple data distribution techniques in accordance with some embodiments.

FIG. 3 depicts a block diagram illustrating processes for managing a flow database table in accordance with some embodiments.

FIG. 4 depicts a block diagram illustrating an exemplary process for performing load balancing/routing operations in accordance with embodiment.

FIG. 5 depicts a first flow diagram illustrating an exemplary process for optimizing path selection for load balancing operations in accordance with at least some embodiments.

FIG. 6 depicts a second first flow diagram illustrating an exemplary process for optimizing path selection for load balancing operations in accordance with at least some embodiments.

FIG. 7 is a schematic block diagram of an example computer network illustratively comprising nodes/devices, such as a plurality of routers/devices interconnected by links or networks, as shown.

FIG. 8 illustrates an example of network in greater detail, according to various embodiments.

FIG. 9 is a computing system diagram illustrating a configuration for a data center that can be utilized to implement aspects of the technologies disclosed herein.

FIG. 10 shows an example computer architecture for a server computer capable of executing program components for implementing the functionality described above.

### DESCRIPTION OF EXAMPLE EMBODIMENTS

### Overview

A first method according to the techniques described herein may include receiving a data packet to be transmitted to a receiving edge device over a set of paths and determining whether a flow associated with the data packet has been allocated via a first data distribution technique. The method may further comprise upon determining that the flow has not been allocated, determining whether the first data distribution technique is available for the flow, upon determining that the first data distribution technique is not available, using a second data distribution technique to distribute the data packet across the set of paths, and upon determining that the first data distribution technique is available, allocating the flow to a path in the set of paths and transmitting the data packet over the path.

A second method according to the techniques described herein may include initially implementing a first data distribution technique to distribute data packets across a set of paths. The method may further comprise determining, based on one or more values associated with the set of paths, that a first path of the set of paths is underutilized and upon receiving a first data packet associated with a data flow, assigning the first data packet to the first path in a table associated with a second data distribution technique. The method may then comprise routing the first data packet across the first path in accordance with the second data distribution technique.

Additionally, the techniques described herein may be performed by a system and/or device having non-transitory computer-readable media storing computer-executable instructions that, when executed by one or more processors, performs the method described above.

### Example Embodiments

This disclosure describes techniques for optimizing data distribution as used in load-balancing (e.g., for routing operations). In embodiments, the techniques may initially implement static hashing to provide equal distribution of data packets across a set of paths. Once a moderate amount of network traffic is being routed, the techniques may switch to flow-based routing to distribute network traffic associated with a flow to an underutilized path, resulting in optimization of path usage. As the number of distributed flows increases (and a flow table fills up), the techniques may switch back to static hashing for at least a portion of the network traffic that is being routed, while limiting path selection to those that are determined to be under-utilized.

Generally, a router performing standard routing procedures may distribute network traffic across a set of available paths. In embodiments, this may involve using one or more (static) hashing techniques to allocate data packets of network traffic across the set of paths. Such techniques may be designed to allocate a roughly equal number of data packets to each of the paths in the set of paths. Static hashing techniques may provide for more even distribution of network traffic across a set of paths, but may be unable to quickly adapt to changing path load conditions. In other words, data distribution techniques that use static hashing may continue to utilize paths that are already overutilized.

Additionally, a router performing flow-based routing evaluates traffic flows in real time (e.g., based on an ID, route, time of receipt, or rate of flow) in order to keep streaming traffic moving as quickly as possible. A flow-based router observes and evaluates flows of multiple packets to gather metrics. Rather than allocating individual packets to different paths, this evaluation permits the router to assign each of the data packets belonging to a particular flow to a single path most suitable to that flow. This, in turn, allows the router to meet service level agreement (SLA) requirements and keep flows from consuming more than a pre-allotted portion of network resources. Flow-based techniques may require the use of a table or other data structure to track path allocation. In such cases, the maximum size of a table may be bounded by hardware limits. Hence, flow-based hashing may not be able to accommodate scenarios in which massive amounts of data are being routed.

Embodiments of the disclosure provide for a number of advantages over conventional systems. For example, the techniques described herein provide for optimization of data packet distribution by dynamically switching between flow-based techniques and those using static hashing. This allows for a router to adapt its load-balancing to changing path load conditions while also being able to accommodate massive amounts of traffic.

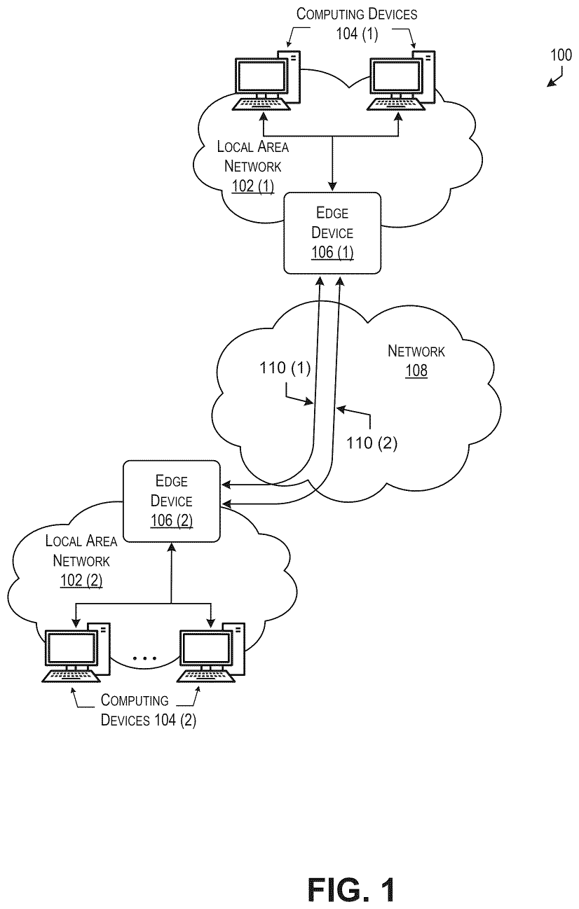

FIG. 1 depicts a block diagram illustrating an example network deployment environment 100 that may be implemented in accordance with at least some embodiments. In FIG. 1, one or more local area network (LAN) 102 (1 and 2) may be accessed by a number of local computing devices 104 (1 or 2) respectively. As depicted, one or more edge device 106 (1 and 2) may be located at the edge of a remote site in order to provide connectivity (e.g., ingress/egress) between a LAN 102 and one or more network 108.

An edge device 106 may include any electronic device that provides an ingress/egress point for a network (e.g., LAN 102). The edge device 106 may act as a router for a client user device (e.g., computing device 104). An example of an edge device 106 may include a router, routing switch, integrated access device, multiplexer, or any other suitable device. The edge device 106 may include one or more processors and a memory that stores computer executable instructions for implementing at least a portion of the functionality described herein.

In some embodiments, one or more of the computing devices 104 may represent computing devices operated by individual users. In some embodiments, the computing devices 104 may represent servers operating on a backend system. For example, the computing devices 104 (1) may represent servers operated by one or more Software as a Service (SaaS) providers that host one or more applications to be accessed by the computing devices 104 (1). In this example, the edge device 106 (1) may provide connectivity to the computing devices 104 (2) (i.e., SaaS providers) via a number of paths (e.g., tunnels) 110 (1 and 2) across any number of networks that make up the Network 108. This allows clients using the LAN 102 of a remote site to access cloud applications (e.g., Office 365™, Dropbox™, etc.) served by computing devices 104 (2).

The network 108 may be implemented across a number of computing devices each acting as nodes in the network 108. The computing devices making up the network 108 may be centralized or clustered in a single location or may be geographically distributed throughout one or more regions.

In some embodiments, the network 108 may include a Software-defined wide area network (SD-WAN) fabric. SD-WANs represent the application of software-defined networking (SDN) principles to WAN connections, such as connections using cellular networks, the Internet, and Multiprotocol Label Switching (MPLS) networks. The power of SD-WAN is the ability to provide consistent SLA for important application traffic transparently across various underlying paths of varying transport quality and allow for seamless path selection based on path performance characteristics that can match application SLAs.

Overseeing the operations of the network 108 may be an SDN controller. In general, an SDN controller may comprise one or more devices configured to provide a supervisory service, typically hosted in the cloud, to the Network 108 and/or one or more SD-WAN service points. For instance, an SDN controller may be responsible for monitoring the operations thereof, promulgating policies (e.g., security policies, etc.), installing or adjusting IPsec routes/tunnels (e.g., paths 110) between LAN 102 (1) and remote destinations such as LAN 102 (2).

As would be appreciated, the network 108 may allow for the use of a variety of different paths 110 (1 and 2) between a first edge device 106 (1) and a second edge device 106 (2). For example, an edge device 106 may include, or may be in communication with, a router configured to route communications over the network 108 to, for example, one or more applications hosted by a SaaS provider. In this example, the edge device 106 (1) (e.g., router) may utilize two Direct Internet Access (DIA) connections to connect with the edge device 106 (2). More specifically, a first interface of the edge device 106 (1) may establish a first communication path 110 (1) (e.g., a tunnel) with edge device 106 (2) via a first Internet Service Provider (ISP). Likewise, a second interface of the router may establish a second (e.g., backhaul) path 110 (2) with edge device 106 (2) via a second ISP. In some embodiments, the edge device 106 (1) may establish a third path via a private corporate network (e.g., an MPLS network) to a private data center or regional hub which, in turn, provides connectivity to the edge device 106 (2) via another network, such as a third ISP.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN 102 (1) to LAN 102 (2). Other deployments scenarios are also possible, such as using Colo, accessing SaaS provider(s) via Zscaler™ or Umbrella™ services, and the like.

In embodiments, an edge device 106 (1) may, upon receiving a data packet to be transmitted over a network 108, identify a set of paths 110 (1 and 2) over which the data packet may be transmitted. The edge device 106 (1) may then use one or more data distribution techniques to distribute the network traffic across the paths in the set of paths. For example, the edge device may use a hashing algorithm that evaluates attributes of a data packet to determine to which path that data packet is to be assigned. Initially, edge device 106 may use techniques intended to allocate a roughly equal number of data packets to each of the paths in the set of paths (e.g., static hashing).

As the network traffic is routed across the set of paths, metrics associated with those paths are collected and analyzed to determine a current load for each of the paths in the set of paths. Based on such a determination, the edge device 106 may identify an average (e.g., median) load for the paths. The edge device 106 may also identify one or more paths in the set of paths that have a current load that is below that average (or below a threshold load value).

The edge device 106 may use the information about the path loads to make a determination as to which paths in the set of paths are capable of meeting SLA requirements for network traffic to be routed. When performing load balancing operations in relation to a data packet, the edge device 106 may limit distribution of the data packet to a subset of the set of paths capable of meeting SLA requirements for the data packet.

Note that data packets may be grouped into a flow based on having similar characteristics like source and destination IP addresses, protocol, and port numbers. In embodiments, it may be beneficial to allocate all data packets from a single flow to the same path (e.g., flow-based routing). This ensures that the data packets from a flow are not received out of order. To that end, the edge device 106 may assign a flow of network traffic to a path that is best suited to meet its SLA requirements. In some cases, this may be one of the paths in the set of paths that is determined (based on the obtained information) to be underutilized. To do this, once a data packet from the flow is allocated to a path (e.g., using a hashing technique), an entry is added to a table that includes a mapping of the flow to the respective path. In some cases, the table entry may include an index that can be used to identify the flow. For example, the index may be an identifier that is generated by hashing data values attributed to data packets in the flow.

In flow-based routing, each time that the edge device 106 receives a data packet to be routed over the Network 108, that edge device consults a table to determine if a flow that includes the data packet has already been assigned to a path. If the flow is already assigned to a path, then the data packet can be routed over that path. Otherwise, the edge device may determine if the flow should be assigned to a path and/or if the table has enough room to make such an assignment. If both are true, then the edge device may allocate the flow to a path in the set of paths and may create a new table entry for that allocation. If either are false, then the edge device may use standard data distribution techniques (e.g., static hashing) to allocate the data packet.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

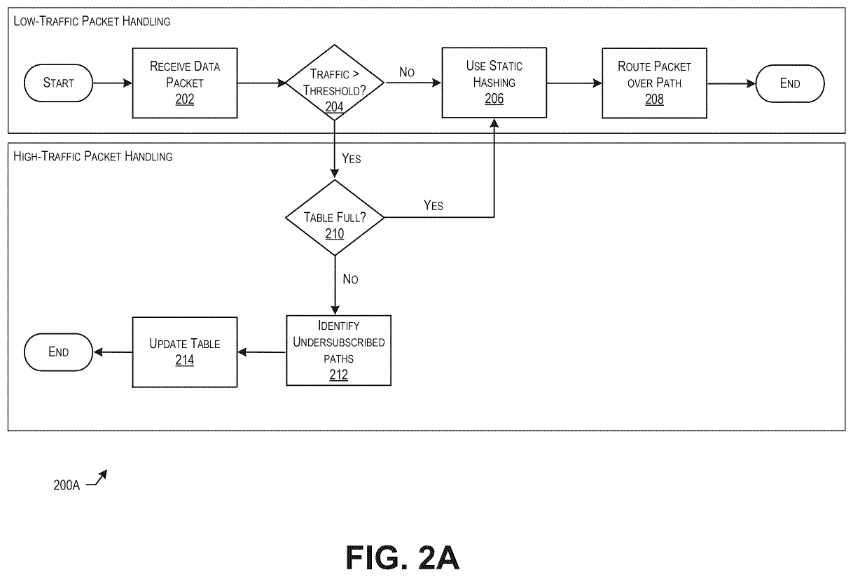

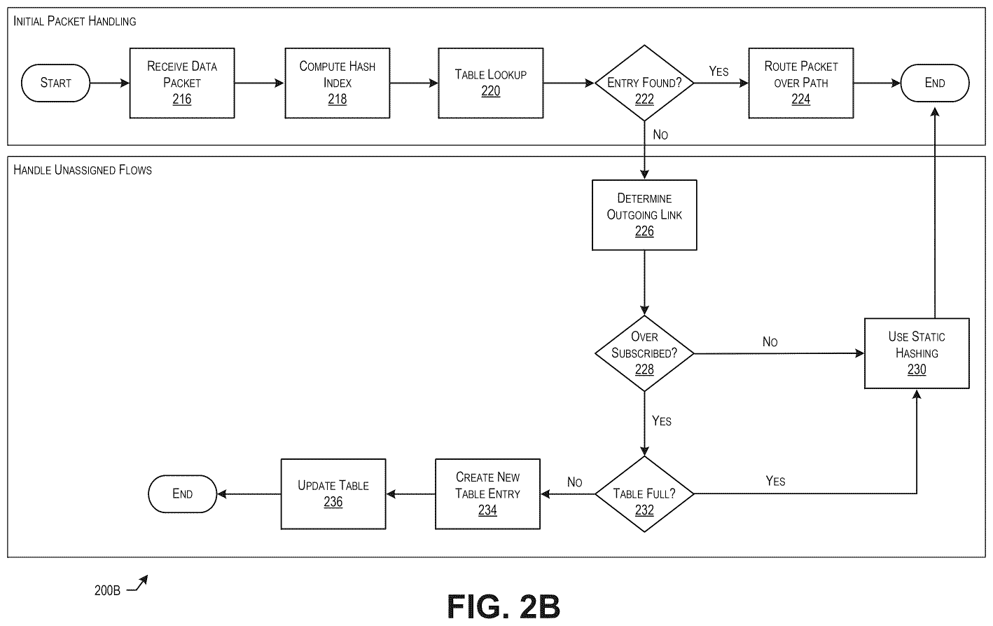

FIG. 2A depicts a first block diagram illustrating a process for distributing data packets dynamically using multiple data distribution techniques in accordance with some embodiments. In embodiments, the process 200B may be performed by an edge device (e.g., edge device 106) that receives a data packet to be routed over a network (e.g., a SD-WAN fabric).

At 202, an edge device receives a data packet to be routed over the network. Upon receiving a data packet, the edge device may determine a flow associated with that data packet. In some cases, the data packet may be determined to be associated with a flow based on information included in metadata (e.g., a header) of the data packet.

At 204, the edge device may make a determination as to whether a current amount of network traffic being handled by the edge device is greater than a threshold amount. In some cases, the threshold amount may be represented as a percentage of the total amount of traffic that the edge device is capable of handling (e.g., 70% of the bandwidth, etc.). In some cases, the threshold amount may be represented as a total traffic flow, such as a number of data packets that are being handled per second.

Provided that the amount of network traffic being handled by the edge device is less than a threshold amount (e.g., “No” at 204), the edge device may then use a static hashing algorithm to assign the data packet to one of the paths in the set of paths at 206. As noted elsewhere, a static hashing algorithm may rely upon pseudo-randomness to assign data packets to paths using information about those data packets. While static hashing algorithms may generally result in a somewhat even distribution of data packets across paths in the set of paths, some paths may be used less than average while other paths may be used more than average. Additionally, path bandwidth may vary and not all paths may be capable of handling the same amount of network traffic. Once the static hashing algorithm has been used to identify a path in the set of paths, the edge device may route the data packet to its destination over that identified path at 208.

Provided that the amount of network traffic being handled by the edge device is greater than or equal to a threshold amount (e.g., “Yes” at 204), the edge device may then attempt to use a flow-based routing algorithm to route the data packet. In such cases, the edge device may first make a determination as to whether flow-based routing is available based on whether there is room in a flow table for a new entry associated with a flow that includes the data packet.

If the flow table is full (e.g., “Yes” at 210), the edge device may revert back to using a static hashing algorithm to route the data packet at 206. However, if there is room in the flow table for a new entry (e.g., “No” at 210), the edge device may identify one or more underutilized paths at 212. In some embodiments, this may involve calculating an average data packet load across the paths in the set of available paths and then identifying one or more paths for which the corresponding data packet load is below that average. In some embodiments, this may involve determining a total load capacity for each of the paths in the set of paths (which may vary by path) and then may determine a used percentage of capacity for the path based on the respective load capacity for that path. In such cases, underutilized paths may be identified based on having the lowest percentage used capacity for those paths.

Once one or more underutilized paths have been identified, the edge device may be configured to allocate a flow (e.g., grouping) that includes the received data packet to one of the paths determined to be underutilized. In some cases, the flow may be allocated to the path determined to be most underutilized. In other cases, the flow may be allocated randomly or pseudo-randomly to one of the paths in the set of paths. To make this allocation, the edge device may calculate a hash index value that corresponds to the flow and update a flow table at 214 to include an entry that maps the hash index value to the allocated path.

In some embodiments, once the edge device makes a determination (e.g., at 204) that it is handling an amount of network traffic that exceeds a threshold amount of network traffic, the edge device may switch from performing process 200A to performing process 200B as described below. Upon the amount of network traffic being handled by the edge device returning to a level below the threshold amount of network traffic, the edge device may then revert to performing process 200A.

FIG. 2B depicts a second block diagram illustrating a process for distributing data packets dynamically using multiple data distribution techniques in accordance with some embodiments. In embodiments, the process 200B may be performed by an edge device (e.g., edge device 106) that receives a data packet to be routed over a network after a threshold amount of traffic has been met at the edge device. In other words, the process 200B may be performed subsequent to the process 200A.

At 216, an edge device receives a data packet to be routed over the network. Upon receiving a data packet, the edge device may determine a flow associated with that data packet. In some cases, the data packet may be determined to be associated with a flow based on information included in metadata (e.g., a header) of the data packet.

At 218, the edge device may initially compute a hash index value for the data packet. This may be done by subjecting information about a flow to which the data packet belongs to a hash algorithm. An example of such information that may be used to calculate a hash index value may include, but is not limited to, an origin address, a destination address (e.g., a MAC or IP address), port numbers, etc.

At 220, the edge device may perform a lookup in a database table (e.g., a flow table) to make a determination as to whether a flow associated with the data packet has already been assigned a path. The lookup may be performed using the calculated hash index (e.g., by identifying a path indicated in a table row associated with the hash index). Such a determination may be made based on whether or not a table entry associated with the hash index currently exists in the table at 222.

Provided that a table entry has been found in a database table (e.g., “Yes” at 222), the edge device may then determine an identifier for a path indicated in the table entry. The edge device may then proceed to route the data packet over the indicated path at 224.

Provided that a table entry has not been found in a database table (e.g., “No” at 222), the edge device may then determine an outgoing link to be used to transmit the data packet at 226. In embodiments, metrics for each of the paths in a set of paths may be assessed in order to determine whether one or more paths is oversubscribed or undersubscribed at 228. In such cases, a subscription level may be determined for each path. For example, a determination may be made as to how many flows are assigned to each path in the set of paths. The path may then be determined to be undersubscribed or oversubscribed based on the number of flows assigned to it. For example, a path may be considered to be undersubscribed if a number of flows assigned to it is below a first threshold value and oversubscribed if the number of flows assigned to it is greater than a second threshold value.

In some embodiments, a determination may be made as to whether there are any undersubscribed paths in the set of paths. A subset of the set of paths may be generated to include any paths determined to be undersubscribed in this manner. If no undersubscribed paths are identified, a determination may be made as to whether any paths are available that are not oversubscribed at 228. In such cases, a subset of the set of paths may be generated to include any paths determined to not be oversubscribed.

If all paths are currently oversubscribed (e.g., “Yes” at 228), then the edge device may use a static hashing technique. In such cases, the data packet may be distributed across the set of paths using a standard hashing technique at 230.

If one or more paths are currently not oversubscribed (e.g., “No” at 228), then the edge device may make a determination as to whether a database table that stores a mapping of flows to paths (e.g., a flow table) is currently full at 232. In other words, a determination may be made as to whether the database table includes one or more empty fields.

If the database table that stores a mapping of flows to paths (e.g., a flow table) is currently full (e.g., “Yes” at 232), then the edge device may use a static hashing technique at 230. In contrast, if the database table that stores a mapping of flows to paths has at least one open entry (e.g., “No” at 232), then the edge device may create a new table entry related to the flow at 234. That table entry may then be updated to allocate the flow to a path that is undersubscribed (or at least not oversubscribed) at 236, such that data packets for the flow that are received in the future will be routed over the allocated path.

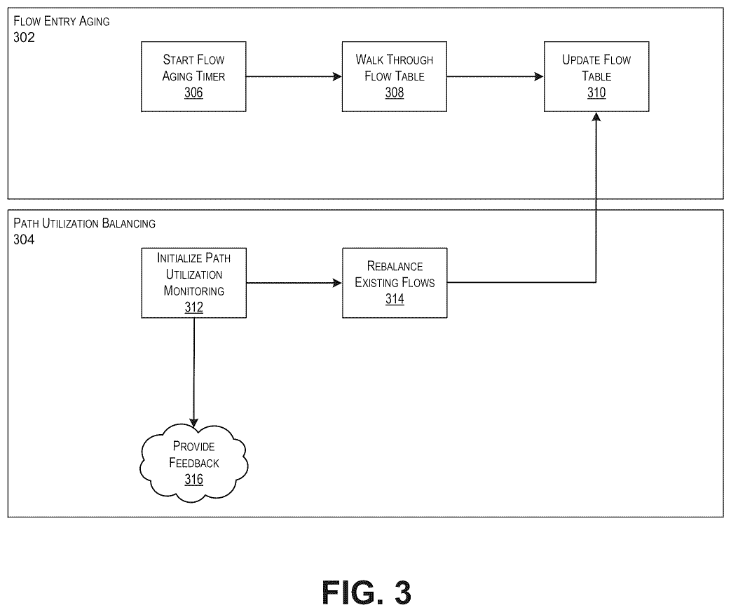

FIG. 3 depicts a block diagram illustrating processes for managing a flow database table in accordance with some embodiments. Particularly, the block diagram illustrates a process 302 for implementing flow entry aging as well as a process 304 for implementing path utilization balancing that may be implemented in accordance with embodiments.

In a flow entry aging process 302, entries in a flow table may be removed (e.g., aged-out) from a flow table after a period of time has elapsed. Alternatively, entries may be removed after a period of time within which no data packets from the flow have been received.

At 306 of the process 302, a flow aging timer may be initiated for a table entry. In embodiments, the flow aging timer may be implemented by virtue of populating a timer data field (e.g., a column) associated with the flow. A determination can be made that a period of time has passed based on the value included in the timer data field. In some cases, the flow aging timer is set upon creation of the flow entry in the table. For example, when a flow entry is created in the flow table, the timer data field may be populated with a current date/time. In some cases, the value in a timer data field may be updated each time that a new data packet associated with the flow is received (and routed). This would effectively reset the aging timer each time that a new data packet is received in that flow.

At 308 of the process 302, a monitoring component may (periodically) walk through the flow table to determine if any of the entries have aged out. In such cases, the monitoring component may identify each of the flows in the flow table having an age that is greater than a threshold amount of time. Particularly, the monitoring component may calculate a date/time that is the threshold amount of time before a current date/time. The monitoring component can then perform a query to identify all flow entries in the flow table that have timer data field entries before the calculated date/time.

At 310 of the process 302, the flow table may be updated to remove flow entries that have aged out. As noted above, a monitoring component may be configured to identify each of the flow entries that have aged out. In such cases, each of the rows of the flow table associated with those flow entries may be deleted or removed to free up space for new entries to be added.

As noted elsewhere, an edge device may further implement a path utilization balancing process 304. At 312 of the process 304, a path utilization monitoring component may be initiated to perform the process. In embodiments, the path utilization monitoring component may be initiated on a periodic basis (e.g., every hour, etc.). In embodiments, the path utilization monitoring component may be initiated upon detecting that one or more paths has become oversubscribed.

Upon initialization, a monitoring component may identify one or more paths as being oversubscribed. To do this, the monitoring component may identify the number of flows that are assigned to each of the paths in the set of paths (e.g., based on a query) to determine if that number is greater than a threshold value. In some cases, a size of each of the flows allocated to a particular path may also be taken into account in order to calculate a total load on each of the paths. A path may be determined to be oversubscribed if the number of flows (or a total load associated with the flows) allocated to that path is greater than a threshold value. Additionally, the monitoring component may be configured to identify one or more paths that are undersubscribed, or at least not oversubscribed.

At 314 of the process 304, the monitoring component may be configured to cause rebalancing of the flow entries in the flow table. This may involve changing a data value associated with one or more flows that are allocated to an oversubscribed path. For example, the monitoring component may update a data value that indicates a path within the flow table from indicating an oversubscribed path to instead indicating an undersubscribed (or not oversubscribed) path at 310. In another example, the monitoring component may simply delete or remove a flow entry from the table that is allocated to an oversubscribed path. In such cases, a new flow entry may be created once a new data packet is received in relation to that flow, which will likely cause it to be assigned to a different path.

In some embodiments, the monitoring component may identify a path/link failure related to one or more paths implemented in a network. In such cases, the monitoring component may be configured to remove the path from a failed set of paths available to be used by one or more edge devices and to cause flows assigned to the failed path to be reassigned to a different path. In some cases, the indicated path value related to an entry in the flow table may be updated or overwritten to indicate a different path. In other cases, an entry for a flow directed to a failed path may be deleted from the flow table entirely. It should be noted that when a new data packet is next received for that flow, a new entry may be created and will be associated with a different (available) path.

In some embodiments, the monitoring component includes (or uses) a machine learning model that has been trained to identify oversubscribed/undersubscribed paths. In such cases, the machine learning model may identify oversubscribed paths as having certain attributes or meeting certain conditions regardless of the number of flows assigned to those paths.

At 316 of the process 304, the monitoring component may provide feedback to be used in adjusting/improving the machine learning model. For example, such feedback may include an indication of one or more values associated with the paths that can be used to draw correlations between path attributes and a status (e.g., “oversubscribed,” “undersubscribed,” etc.).

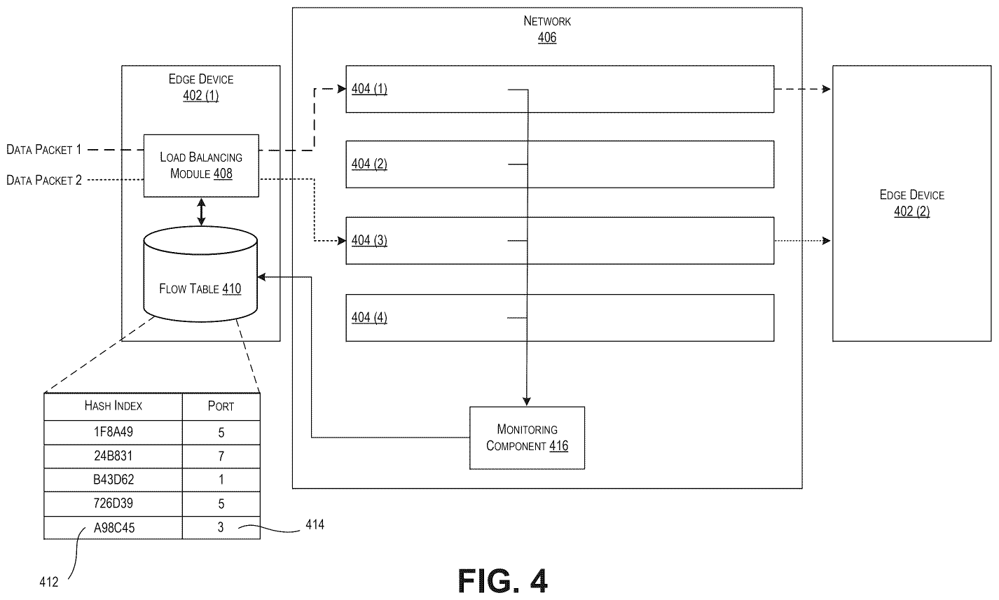

FIG. 4 depicts a block diagram illustrating an exemplary process for performing load balancing/routing operations in accordance with embodiment. As noted elsewhere, an (source) edge device 402 (1) may be configured to route communications over a number of paths 404 (1-4) in a network 406 to at least one second (receiving) edge device 402 (2).

In embodiments, one or more paths 404 may be identified between the edge device 402 (1) and the edge device 402 (2). In some embodiments, the multiple paths are identified using one or more probes (e.g., TCP probes). Each path between a source and a destination may be traversed by a probe packet such that the receiving edge device 402 (2) receives a number of probe packets that corresponds to approximately the total number of paths between the source edge device 402 (1) and the receiving edge device 402 (2) (destination). Typically, the number of probe packets received at a destination may correspond to the total number of equal costs paths.

By way of example, if there are four paths between a source and a destination, regardless of how many probe packets are initially transmitted by the edge device 402 (1), due to potentially replicating a probe packet at an intermediate hop which has two associated next hops, the destination (edge device 402 (2)) receives four probe packets. In such cases, the probe may be used to collect information about each of the hops along the path. That information can then be used by the edge device 402 (1) (or another suitable device) to identify at least one path that may be used to convey information across the network 206 from the edge device 402 (1) to the edge device 402 (2).

In embodiments, an edge device 402 (1) may include computer-readable media that stores various executable components (e.g., software-based components, firmware-based components, etc.). The computer-readable media may store components to implement functionality described herein. The computer-readable media may include portions, or components, that configure the edge device 402 (1) to perform various operations described herein. For example, the computer-readable media may include some combination of components configured to implement the described techniques. Particularly, the computer-readable media may include a component configured to perform load balancing operations (e.g., load balancing module 408). Additionally, an edge device 402 (1) may include one or more database tables, such as a flow table 410 that includes a mapping between data flows and paths.

In embodiments, a load balancing module 408 may be configured to, when executed in conjunction with one or more processors, allocate a received data packet to one of multiple available paths associated with a destination (e.g., edge device 402 (2)). In order to do this, the load balancing module 408 may be configured to operate using multiple different load balancing (data packet distribution) techniques in accordance with the disclosure.

In operation, when the load balancing module 408 receives a data packet to be transmitted to the edge device 402 (2), the load balancing module 408 may initially attempt to use flow-based routing. In doing so, the load balancing module 408 may first calculate a hash index value for that data packet using one or more hash algorithms and information about the data packet. The information about the data packet may be unique to a flow that includes that data packet rather than to the data packet itself. For example, exemplary information that can be used to generate a hash index value may include, but is not limited to, a source identifier/IP address, a destination identifier/IP address, a flow identifier, an application identifier, etc. The hash index value for the data packet can then be compared to hash index values 412 in a column of the flow table to determine if an entry (e.g., a row) associated with the data packet (or more particularly a flow that includes the data packet) already exists within the flow table 410. If an entry does already exist in the flow table 410 for the data packet, then the load balancing module 408 may be configured to transmit the data packet over a path 414 as indicated in the entry.

Provided that an entry for the data packet does not already exist within the flow table 410, the load balancing module 408 may be configured to make a determination about whether an entry can (or should) be created in the flow table 410. Initially, the load balancing module 408 may determine whether there are any paths that are not currently oversubscribed. If not, then the load balancing module 408 may elect to use a second data distribution technique (such as a static hashing technique) to allocate the data packet to a selected path from paths 404 (1-4). If there are paths that are not currently oversubscribed, then a determination may be made as to whether there is availability in the flow table 410 for a new entry related to the flow. Provided that paths exist that are not oversubscribed and there is availability to add at least one entry to the flow table 410, an entry for the data packet may be added with the respective generated hash index value. In some cases, the path to be allocated to the data packet in the flow table 410 may be determined using a static hashing technique but while limiting the available set of paths to just those that are not oversubscribed (or in some cases are undersubscribed). In this scenario, data packets from the same flow that are received in the future may result in generation of the same hash index value and may then be directed over the selected path.

In embodiments, the network 406 may include a monitoring component 416 that is implemented on at least one device or node operating on the network 406. In some cases, the monitoring component 416 may be configured to receive information about the paths 404 implemented in the network 406 and to determine a current operating status/load for individual paths based on that information. In some cases, the monitoring component 416 may be configured to identify paths that are oversubscribed based on the received information. For example, the monitoring component may determine that utilization of a path is greater than a threshold utilization value. Upon determining that a particular path is oversubscribed, the monitoring component 416 may be configured to provide instructions to the edge device 402 (1) to reallocate at least a portion of the flow table so that some of the flows assigned to that path are reassigned to a different path. Alternatively, the monitoring component 416 may be configured to identify undersubscribed paths and to provide instructions to the edge device 402 (1) to reallocate at least a portion of the flow table so that some of the flows assigned to other paths are reassigned to the undersubscribed path.

In some embodiments, the monitoring component 416 may use or include a trained machine learning model. The monitoring component 416 constantly assesses the load on each path to make smart and informed decisions. In some cases, the monitoring component 416 may be configured to learn maximum threshold values for each of the multiple paths 404 implemented in the network 406. Hence, the monitoring component 416 may be configured to determine that a particular path is oversubscribed/overutilized upon determining that the load on that particular path is greater than a threshold value associated with that path.

In some cases, the monitoring component 416 may be configured to assess a load associated with a particular flow based on a rate of data packet transmission for that flow. In such cases, the monitoring component 416 may be configured to cause the flow to be reassigned in a flow table from a first path to a second path that is more optimal for that flow based on the load. For example, upon determining that a flow is associated with a very heavy load, the monitoring component 416 may be configured to identify an underutilized path to be assigned to that flow in the flow table 410.

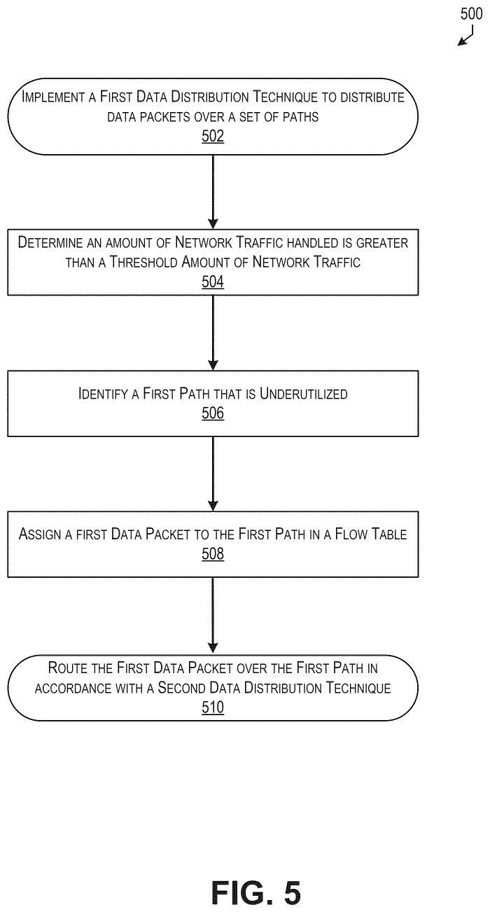

FIG. 5 depicts a first flow diagram illustrating an exemplary process for optimizing path selection for load balancing operations in accordance with at least some embodiments. In embodiments, the process 500 may be performed with respect to one or more devices capable of routing communications over a network, such as an edge device (e.g., edge device 106 of FIG. 1).

At 502, the process 500 may involve implementing a first data distribution technique to distribute data packets across a set of paths. In some embodiments, the first data distribution technique comprises a hashing technique to distribute data packets across the set of paths in a pseudo random manner.

At 504, the process 500 may involve determining whether an amount of network traffic handled by the edge device is significant. More particularly, a determination is made that the amount of network traffic handled by the edge device is greater than a threshold amount of network traffic.

At 506, the process 500 may involve identifying at least one path of a set of available paths that is currently underutilized. The at least one identified path may be designated as a first path to be assigned to a flow for use in data packet routing. In embodiments, the first path of the set of paths is identified as being underutilized if a current load associated with the first path is below an average load for the set of paths.

At 508, the process 500 may involve receiving a first data packet to be transmitted to a destination (e.g., a receiving edge device) and assigning that first data packet to the first path in a flow table. In embodiments, the data packet is received from a client device in communication with the source edge device. In embodiments, the data packet is directed to a client device in communication with the receiving edge device. Notably, this may involve generating a hash index value based on information about the data packet and entering the hash index value into the flow table with a mapping to the first path. In such cases, the information about the data packet used to generate the hash index value may include at least one of a source address or destination address associated with the data packet.

At 510, the process 500 may involve routing the data packet over the first path in accordance with a second data distribution technique based on the assignment in the flow table. In embodiments, the second data distribution technique comprises a flow-based technique.

In some embodiments, the process 500 may further involve receiving a second data packet directed to the destination device, determining that the second data packet is associated with the first data packet based on the flow table, and upon determining the that the second data packet is associated with the first data packet, routing the second data packet across the first path in accordance with the second data distribution technique.

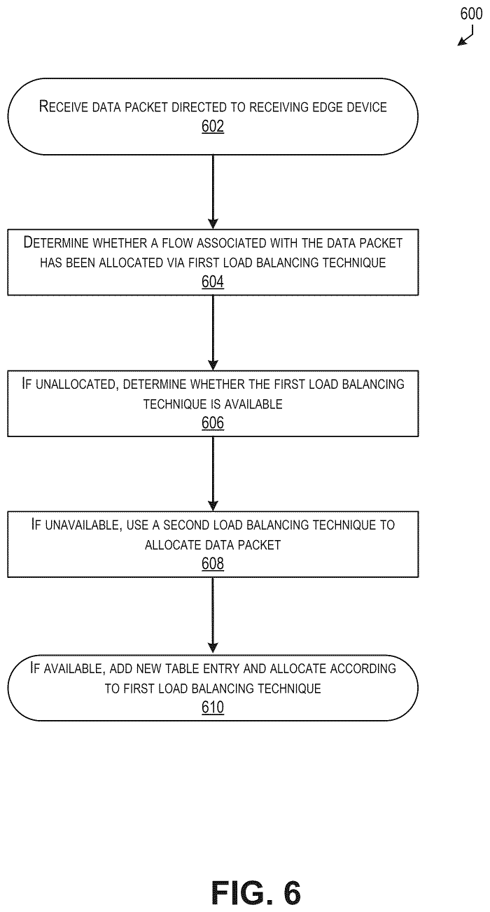

FIG. 6 depicts a second flow diagram illustrating an exemplary process for optimizing path selection for load balancing operations in accordance with at least some embodiments. In embodiments, the process 600 may be performed with respect to one or more devices capable of routing communications over a network, such as an edge device (e.g., edge device 106 of FIG. 1).

At 602, the process 600 may involve receiving a data packet to be transmitted to a destination (e.g., a receiving edge device). In embodiments, the data packet is received from a client device in communication with the source edge device. In embodiments, the data packet is directed to a client device in communication with the receiving edge device.

At 604, the process 600 may involve determining whether the data packet belongs to a flow that has already been allocated to a path using a first data distribution technique. In embodiments, the first data distribution technique may be a flow-based technique. In some cases, determining whether the flow has been allocated may involve determining whether the flow is associated with an entry that is already included in a flow table stored in a memory of the edge device. In these cases, the flow is determined to be associated with an entry in a flow table if a hash index value generated based on information about the flow matches the entry included in the flow table.

At 606, the process 600 may involve, upon determining that the flow has not been allocated, determining whether the first data distribution technique is available for the flow. In some embodiments, determining whether the first data distribution technique is available for the flow may involve determining whether at least one path in the set of paths is not oversubscribed. In such cases, a path is not oversubscribed if a current load associated with the path is below a first threshold load. In some embodiments, determining whether the first data distribution technique is available for the flow may involve determining whether an entry can be created in a flow table associated with the first data distribution technique.

At 608, the process 600 may involve, upon determining that the first data distribution technique is not available, using a second data distribution technique to distribute the data packet across the set of paths. In embodiments, the second data distribution technique may be a hashing technique.

At 610, the process 600 may involve, upon determining that the first data distribution technique is available, allocating the flow to a path in the set of paths and transmitting the data packet over the path.

The process 600 may further involve at a later date/time receiving a second data packet and determining that the second data packet is associated with the data flow. In embodiments, the second data packet is determined to be associated with the data flow based on a hash index value generated from information associated with the second data packet matching information in the entry to the flow table. The process 600 may then involve routing the second data packet across the first path in accordance with the second data distribution technique.

The process 600 may further involve determining that a second path of the set of paths has failed and updating one or more entries in the flow table associated with the second path to prevent data packets from being transmitted over the second path. In some cases, the one or more entries in the flow table are updated to change an indication of the second path to an indication of a third path. In other cases, the one or more entries in the flow table are deleted.

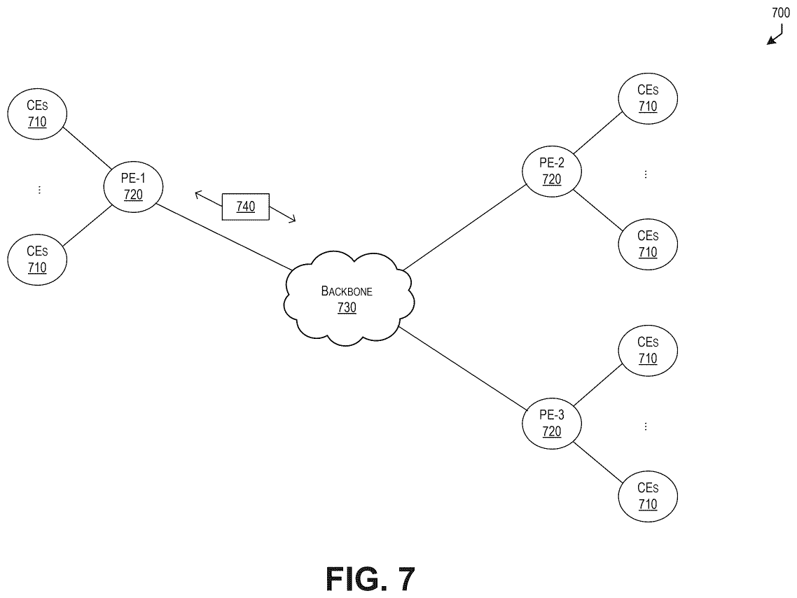

FIG. 7 is a schematic block diagram of an example computer network 700 illustratively comprising nodes/devices, such as a plurality of routers/devices interconnected by links or networks, as shown. A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANS). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to pre-defined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

In the depicted example, customer edge (CE) routers 710 may be interconnected with provider edge (PE) routers 720 (e.g., PE-1, PE-2, and PE-3) in order to communicate across a core network, such as an illustrative network as backbone 730. For example, routers 710, 720 may be interconnected by the public Internet, a multiprotocol label switching (MPLS) virtual private network (VPN), or the like. Data packets 740 (e.g., traffic/messages) may be exchanged among the nodes/devices of the computer network 700 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 710 shown in network 700 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected is to network 700 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2, or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 710 connected to PE-2 and a second CE router 710 connected to PE-3.

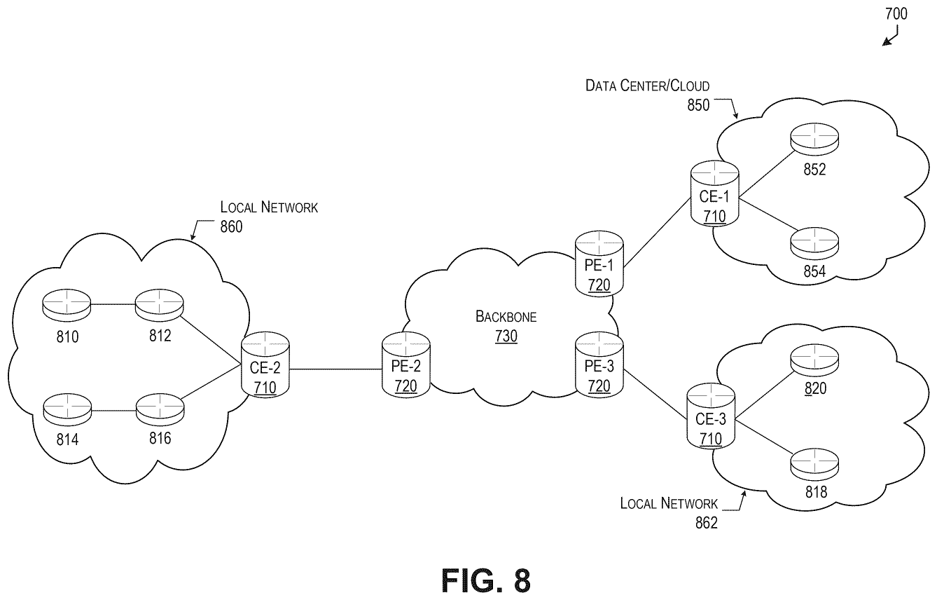

FIG. 8 illustrates an example of network 700 in greater detail, according to various embodiments. As shown, network backbone 730 may provide connectivity between devices located in different geographical areas and/or different types of local networks. For example, network 700 may comprise local/branch networks 860, 862 that include devices/nodes 810-816 and devices/nodes 818-820, respectively, as well as a data center/cloud 850 that includes servers 852-854. Notably, local networks 860-862 and data center/cloud 850 may be located in different geographic locations.

Servers 852-854 may include, in various embodiments, a network management server (NMS), a dynamic host configuration protocol (DHCP) server, a constrained application protocol (COAP) server, an outage management system (OMS), an application policy infrastructure controller (APIC), an application server, etc. As would be appreciated, network 700 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software defined WAN (SD-WAN) may be used in network 700 to connect local network 860, local network 862, and data center/cloud 850. In general, an SD-WAN uses a software defined networking (SDN)-based approach to instantiate tunnels on top of the physical network and control routing decisions, accordingly. For example, as noted above, one tunnel may connect router CE-2 at the edge of local network 860 to router CE-1 at the edge of data center/cloud 850 over an MPLS or Internet-based service provider network in backbone 730. Similarly, a second tunnel may also connect these routers over a 4G/5G/LTE cellular service provider network. SD-WAN techniques allow the WAN functions to be virtualized, essentially forming a virtual connection between local network 860 and data center/cloud 850 on top of the various underlying connections. Another feature of SD-WAN is centralized management by a supervisory service that can monitor and adjust the various connections, as needed.

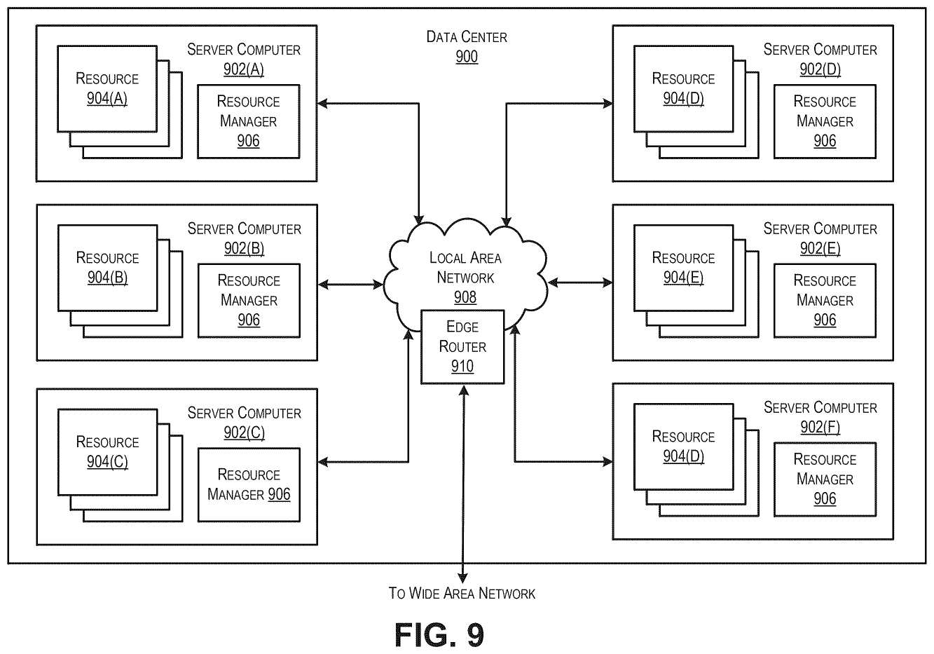

FIG. 9 is a computing system diagram illustrating a configuration for a data center 900 that can be utilized to implement aspects of the technologies disclosed herein. The example data center 900 shown in FIG. 9 includes several server computers 902A-902F (which might be referred to herein singularly as “a server computer 902” or in the plural as “the server computers 902”) for providing computing resources. In some examples, the resources and/or server computers 902 may include, or correspond to, the any type of networked device described herein. Although described as servers, the server computers 902 may comprise any type of networked device, such as servers, switches, routers, hubs, bridges, gateways, modems, repeaters, access points, etc.

The server computers 902 can be standard tower, rack-mount, or blade server computers configured appropriately for providing computing resources. In some examples, the server computers 902 may provide computing resources 904 including data processing resources such as VM instances or hardware computing systems, database clusters, computing clusters, storage clusters, data storage resources, database resources, networking resources, and others. Some of the server computers 902 can also be configured to execute a resource manager 906 capable of instantiating and/or managing the computing resources. In the case of VM instances, for example, the resource manager 906 can be a hypervisor or another type of program configured to enable the execution of multiple VM instances on a single server computer 902. Server computers 902 in the data center 900 can also be configured to provide network services and other types of services.

In the example data center 900 shown in FIG. 9, an appropriate LAN 908 is also utilized to interconnect the server computers 902A-902F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 900, between each of the server computers 902A-902F in each data center 900, and, potentially, between computing resources in each of the server computers 902. It should be appreciated that the configuration of the data center 900 described with reference to FIG. 9 is merely illustrative and that other implementations can be utilized.

In some examples, the server computers 902 may each execute one or more application containers and/or virtual machines to perform techniques described herein.

In some instances, the data center 900 may provide computing resources, like application containers, VM instances, and storage, on a permanent or an as-needed basis. Among other types of functionality, the computing resources provided by a cloud computing network may be utilized to implement the various services and techniques described above. The computing resources 904 provided by the cloud computing network can include various types of computing resources, such as data processing resources like application containers and VM instances, data storage resources, networking resources, data communication resources, network services, and the like.

Each type of computing resource 904 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 904 not mentioned specifically herein.

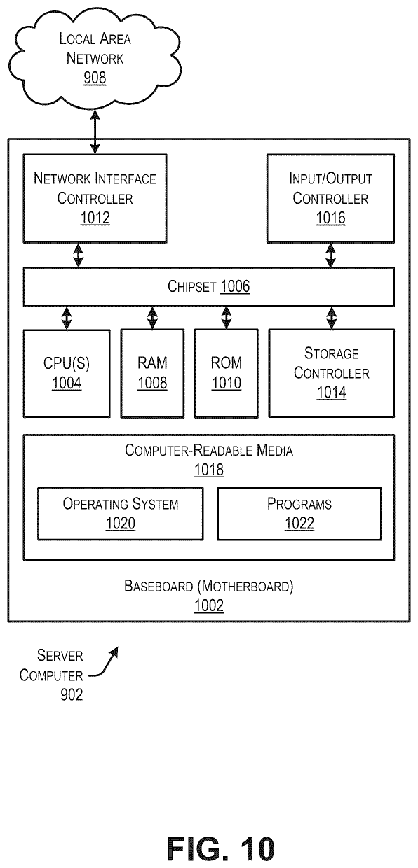

The computing resources 904 provided by a cloud computing network may be enabled in one embodiment by one or more data centers 900 (which might be referred to herein singularly as “a data center 900” or in the plural as “the data centers 900”). The data centers 900 are facilities utilized to house and operate computer systems and associated components. The data centers 900 typically include redundant and backup power, communications, cooling, and security systems. The data centers 900 can also be located in geographically disparate locations. One illustrative embodiment for a data center 900 that can be utilized to implement the technologies disclosed herein will be described below with regard to FIG. 10.

The LAN 908 may be configured to enable connectivity between the server computers 902(A-F) and an external wide area network (WAN). In some embodiments, this is accomplished via an edge router 910 in communication with the LAN 908. Such an edge router 910 may use any suitable routing protocols to route communications between the various components depicted.

FIG. 10 shows an example computer architecture for a server computer 902 capable of executing program components for implementing the functionality described above. The computer architecture shown in FIG. 10 illustrates a conventional server computer, workstation, desktop computer, laptop, tablet, network appliance, e-reader, smartphone, or other computing device, and can be utilized to execute any of the software components presented herein. The server computer 902 may, in some examples, correspond to a physical server as described herein, and may comprise networked devices such as servers, switches, routers, hubs, bridges, gateways, modems, repeaters, access points, etc.

The server computer 902 includes a baseboard 1002, or “motherboard,” which is a printed circuit board to which a multitude of components or devices can be connected by way of a system bus or other electrical communication paths. In one illustrative configuration, one or more central processing units (“CPUs”) 1004 operate in conjunction with a chipset 1006. The CPUs 1004 can be standard programmable processors that perform arithmetic and logical operations necessary for the operation of the server computer 902.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a RAM 1008, used as the main memory in the server computer 902. The chipset 1006 can further provide an interface to a computer-readable storage medium such as a read-only memory (“ROM”) 1010 or non-volatile RAM (“NVRAM”) for storing basic routines that help to startup the server computer 902 and to transfer information between the various components and devices. The ROM 1010 or NVRAM can also store other software components necessary for the operation of the server computer 902 in accordance with the configurations described herein.

The server computer 902 can operate in a networked environment using logical connections to remote computing devices and computer systems through a network, such as the LAN 908. The chipset 1006 can include functionality for providing network connectivity through a NIC 1012, such as a gigabit Ethernet adapter. The NIC 1012 is capable of connecting the server computer 902 to other computing devices over the LAN 908 (and/or 108). It should be appreciated that multiple NICs 1012 can be present in the server computer 902, connecting the computer to other types of networks and remote computer systems.

The server computer 902 can be connected to a storage device 1018 that provides non-volatile storage for the computer. The storage device 1018 can store an operating system 1020, programs 1022, and data, which have been described in greater detail herein. The storage device 1018 can be connected to the server computer 902 through a storage controller 1014 connected to the chipset 1006. The storage device 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 902 can store data on the storage device 1018 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 061018 is characterized as primary or secondary storage, and the like.

For example, the server computer 902 can store information to the storage device 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 902 can further read information from the storage device 1018 by detecting the physical states or characteristics of one or more particular locations within the physical storage units.

In addition to the mass storage device 1018 described above, the server computer 902 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 902. In some examples, the operations performed by devices as described herein may be supported by one or more devices similar to server computer 902. Stated otherwise, some or all of the operations performed by the edge device 106, and/or any components included therein, may be performed by one or more server computer 902 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1018 can store an operating system 1020 utilized to control the operation of the server computer 902. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1018 can store other system or application programs and data utilized by the server computer 902.

In one embodiment, the storage device 1018 or other computer-readable storage media is encoded with computer-executable instructions which, when loaded into the server computer 902, transform the computer from a general-purpose computing system into a special-purpose computer capable of implementing the embodiments described herein. These computer-executable instructions transform the server computer 902 by specifying how the CPUs 1004 transition between states, as described above. According to one embodiment, the server computer 902 has access to computer-readable storage media storing computer-executable instructions which, when executed by the server computer 902, perform the various processes described above with regard to FIGS. 1-6. The server computer 902 can also include computer-readable storage media having instructions stored thereupon for performing any of the other computer-implemented operations described herein.

The server computer 902 can also include one or more input/output controllers 1016 for receiving and processing input from a number of input devices, such as a keyboard, a mouse, a touchpad, a touch screen, an electronic stylus, or other type of input device. Similarly, an input/output controller 1016 can provide output to a display, such as a computer monitor, a flat-panel display, a digital projector, a printer, or other type of output device. It will be appreciated that the server computer 902 might not include all of the components shown in FIG. 10, can include other components that are not explicitly shown in FIG. 7, or might utilize an architecture completely different than that shown in FIG. 10.

As described herein, the server computer 902 may include one or more hardware processors (e.g., CPU 1004) configured to execute one or more stored instructions. The processors may comprise one or more cores. Further, the server computer 902 may include one or more network interfaces configured to provide communications between the computer 902 and other devices, such as the communications described herein as being performed by the edge device 106. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the LAN 908. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 1022 may comprise any type of programs or processes to perform the techniques described in this disclosure. The programs 1022 may comprise any type of program that cause the server computer 902 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause server computer 902 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANS (SD-WANs), traffic between individual sites is sent over tunnels. The tunnels are configured to use different switching fabrics, such as MPLS, Internet, 4G or 5G, etc. Often, the different switching fabrics provide different quality of service (QoS) at varied costs. For example, an MPLS fabric typically provides high QoS when compared to the Internet but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfied, based on the switching fabric that it uses. During runtime, the SD-WAN edge router then maps the application traffic to an appropriate tunnel.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. An edge device, comprising:
one or more processors; and
one or more non-transitory computer-readable media storing computer-executable instructions that, when executed by the one or more processors, cause the edge device to perform operations comprising:
implementing a first data distribution technique to distribute data packets across a set of paths;
upon determining an amount of network traffic handled by the edge device is above a threshold amount of network traffic, identifying, based on one or more values associated with the set of paths, that a first path of the set of paths is underutilized;
receiving a first data packet directed to a destination;
assigning the first data packet to the first path in a flow table associated with a second data distribution technique; and
routing the first data packet across the first path in accordance with the second data distribution technique.

2. The edge device of claim 1, wherein the first data distribution technique comprises a hashing technique.

3. The edge device of claim 1, wherein the second data distribution technique comprises a flow-based technique.

4. The edge device of claim 1, wherein the operations further comprise generating a hash index value based on information about the data packet, wherein the hash index value is entered into the flow table.

5. The edge device of claim 4, wherein the information about the data packet comprises information about at least one of a source address or destination address associated with the data packet.

6. The edge device of claim 1, wherein the operations further comprise:
receiving a second data packet directed to the destination device;
determining that the second data packet is associated with the first data packet based on the flow table; and
upon determining the that the second data packet is associated with the first data packet, routing the second data packet across the first path in accordance with the second data distribution technique.

7. The edge device of claim 1, wherein the first path of the set of paths is identified as being underutilized if a current load associated with the first path is below an average load for the set of paths.

8. A method comprising:
implementing, by an edge device, a first data distribution technique to distribute data packets across a set of paths;
upon determining an amount of network traffic handled by the edge device is above a threshold amount of network traffic, identifying, based on one or more values associated with the set of paths, that a first path of the set of paths is underutilized;
receiving a first data packet directed to a destination;
assigning the first data packet to the first path in a flow table associated with a second data distribution technique; and
routing the first data packet across the first path in accordance with the second data distribution technique.

9. The method of claim 8, wherein the first data distribution technique comprises using a hash algorithm to distribute data packets across the set of paths in a pseudo random manner.

10. The method of claim 8, wherein the first data packet is received from a client device in communication with the edge device.

11. The method of claim 8, wherein the data packet is directed to a client device in communication with the destination.

12. The method of claim 8, wherein the destination comprises a second edge device accessible over the set of paths.

13. The method of claim 12, wherein the set of paths are implemented within a network.

14. The method of claim 8, further comprising:
generating a hash index value based on information about the data packet; and
entering the hash index value is entered into the flow table.

15. The method of claim 14, wherein the information about the data packet comprises information about at least one of a source address or destination address associated with the data packet.

16. The method of claim 8, further comprising:
determining that a second path of the set of paths has failed; and
updating one or more entries in the flow table associated with the second path to prevent data packets from being transmitted over the second path.

17. A method comprising:
receiving, at a source edge device, a data packet to be transmitted to a receiving edge device over a set of paths;
determining, by the source edge device, whether a flow associated with the data packet has been allocated via a first data distribution technique;
upon determining that the flow has not been allocated, determining whether the first data distribution technique is available for the flow;
upon determining that the first data distribution technique is not available, using a second data distribution technique to distribute the data packet across the set of paths; and
upon determining that the first data distribution technique is available, allocating the flow to a path in the set of paths and transmitting the data packet over the path.

18. The method of claim 17, wherein determining whether the first data distribution technique is available for the flow comprises determining whether at least one path in the set of paths is not oversubscribed.

19. The method of claim 18, wherein the at least one path in the set of paths is not oversubscribed if a current load associated with the at least one path is below a first threshold load.

20. The method of claim 17, wherein determining whether the first data distribution technique is available for the flow comprises determining whether an entry can be created in a flow table associated with the first data distribution technique.
